(19) United States
(12) Patent Application Publication
(10) Pub. No.: US 2006/0212415 A1
(43) Pub. Date: Sep. 21, 2006

(54) Query-less searching

(76) Inventors: Alejandro Backer, Altadena, CA (US); Joseph Gonzalez, Glen Allen, VA (US)

Correspondence Address: STATTLER, JOHANSEN, AND ADELI LLP, 1875 CENTURY PARK EAST SUITE 1360, CENTURY CITY, CA, 90067, US

(21) Appl. No.: 11/367,021

(22) Filed: Mar. 1, 2006

Related U.S. Application Data
(60) Provisional application No. 60/657,472, filed on Mar. 1, 2005.

(51) Int. Cl. G06N 5/00

(52) U.S. Cl. 706/45

(57) ABSTRACT

Some embodiments of the invention provide a method for identifying relevant documents. The method receives a set of reference documents. The method analyzes the received set of reference documents. Based on this analysis, the method then identifies one or more documents that are potentially relevant to the discussion in one or more reference documents. In some embodiments, the method identifies the relevant documents by examining candidate documents that are on a computer or are accessible by a computer through a computer network (e.g., a local area network, a wide area network, or a network of networks, such as the Internet). In these embodiments, the method uses its analysis of the reference document set to determine whether the discussion (i.e., content) of the candidate document is relevant to the topics discussed in one or more of the reference documents. If so, the method of some embodiments identifies the candidate document as a potentially relevant document (i.e., as a document that is potentially relevant or related to the reference document set).

### CLAIM OF BENEFIT TO RELATES APPLICATION

This application claims benefit to U.S. Patent Provisional Application 60/658,472, filed Mar. 1, 2005, entitled “Query-less search & Document Ranking through a computational model of Curiosity Maximizing learning from Text.”This provisional application is herein incorporated by reference.

### FIELD OF THE INVENTION

The present invention relates to a method for query-less searching.

### BACKGROUND

New technologies and communication media have enabled researchers to collect data faster than they can be assimilated. To manage information overload, powerful query driven technologies (Google, CiteSeer, etc. . . . ) have been developed. However, query driven research is time consuming and limited to the query generated by the user. The search for information is not unique to researchers alone; it affects all people. Information itself takes many forms, from text, the topic of this paper, to video, to raw data to abstract facts. Threats, sources of foods, and environmental characteristics are examples of information important to almost all organisms. The very essence of exploration and curiosity are manifestations of the importance of information.

New technologies have enabled researchers to collect data and publish at increasing rates. With the Internet, publication costs have been virtually eliminated, enabling the distribution of notes, reviews, and preliminary findings. However, the rate at which researchers can find and assimilate relevant information remains constant. Consequently, there is a need for a mechanism to connect the appropriate audience with the appropriate information.

While field-specific journals attempt to select information relevant to their readers, the lines that once separated fields are blurring and new irregular fields are emerging. The information that is relevant and novel to individual researchers even in the same field may vary substantially. Meanwhile, information may be published in the wrong journal or not in enough journals to reach the full potential audience.

Often information may be useful in seemingly orthogonal disciplines. For example, it is unlikely that an economist would read a neurobiology paper published in a biological journal. However, that paper may contain an explanation behind the hominid neural reward mechanism that could ultimately lead to a new understanding of utility. Even if the economist makes this discovery she will find it difficult to choose the single appropriate venue in which to publish her results.

Currently, the primary technique for predicting future reading preferences from prior reading is peer recommendation. Usually a large database tracks user reading habits. The database can then be used to compute the probability that a user would have read a document given that a user has also read some subset of the available documents. Candidate documents with the highest probability of being read are a suggested first. This is similar to the technique used at Amazon.com.

Often reading history or basic questionnaires are used to cluster users. These clusters along with the prior reading database are then used to generate preference predictions. If a subset of users finds a particular document interesting then it is recommended to the other users in their cluster.

The peer recommendation technique has the primary disadvantage that documents that have not yet been read cannot be ranked. Furthermore, literature in a niche field may not be read by enough people to have predictive power in the peer recommendation model. Additionally users may not appropriately rank documents thereby affecting the results obtained by other users.

An alternative to the peer recommendation technique is to apply a similarity metric to assess the difference between the documents already read by the user and each candidate document. One of the more promising approaches is latent semantic index (“LSI”). This is an extension of a powerful text analysis technique known as latent semantic analysis (“LSA”). By applying LSA to a larger collection of general literature (usually general knowledge encyclopedias), a numerical vector definition is constructed for each word. The normalized inner product of these word vectors provides a numerical measure of conceptual similarity between each candidate document and the corpus of prior reading. This metric is used to rank candidate documents in order of decreasing conceptual similarity.

While similar documents are likely relevant, they may not contribute any new information. Often a user wants documents that are similar but not too similar. The “Goldilocks Principle” states that there is an ideal balance between relevance and novelty. A document that is too similar does not contain enough new information while a document that is too dissimilar contains too much new information and will likely be irrelevant or not readily understood. This principle has been extended to latent semantic indexing to rank candidate documents relative to an arbitrarily chosen ideal conceptual distance. However, details are lost in the construction of an average semantic vector for the entire corpus reading. Outlier papers corpus will not be fairly represented and new documents that extend information in those papers will be ignored.

Therefore there is a need in the art for a new technology that actively collects, reviews, and disseminates publications to the appropriate audience. Search engines attempt to accomplish this though queries. However, the prevalent query driven search paradigm is ultimately limited by the quality of the query. It has been found that people use same word to describe an object only about 10 to 20% of the time. For example, an economist would not likely search for utility using the terminology of the dopamine system. Furthermore, these search engines require the active participation of the researchers in posing queries and reviewing intermediary results. Therefore, there is a need in the art for a new autonomous search technology that adaptively selects documents that maximize the learning of the reader based on prior reading.

### SUMMARY OF THE INVENTION

Some embodiments of the invention provide a method for identifying relevant documents. The method receives a set of reference documents. The method analyzes the received set of reference documents. Based on this analysis, the method then identifies one or more documents that are potentially relevant to the discussion in one or more reference documents.

In some embodiments, the method identifies the relevant documents by examining candidate documents that are on a computer or are accessible by a computer through a computer network (e.g., a local area network, a wide area network, or a network of networks, such as the Internet). In these embodiments, the method uses its analysis of the reference document set to determine whether the discussion (i.e., content) of the candidate document is relevant to the topics discussed in one or more of the reference documents. If so, the method of some embodiments identifies the candidate document as a potentially relevant document (i.e., as a document that is potentially relevant or related to the reference document set).

Other embodiments do not identify a candidate document as a potentially relevant document just because the candidate document's discussion is relevant to the topics discussed in the reference document set. To identify a candidate document as a potentially relevant document, some embodiments require that the candidate document's discussion is sufficiently novel over the discussion in the reference document set. Accordingly, in some embodiments, the method further determines whether each candidate document's discussion is sufficiently novel (e.g., the discussion is new or provides a new context or a new meaning to terms and topics that are discussed in the reference document set) to warrant identifying the candidate document as a potentially relevant document.

In some embodiments, the method prepares a presentation of the potentially relevant documents. A user then reviews the documents identified in this presentation to determine which, if any, are relevant to the discussion in one or more reference documents.

The method of some embodiments analyzes and compares reference and candidate documents as follows. To analyze the reference document set, the method computes a first metric value set for the reference document set. The first metric value set quantifies a first knowledge level provided by one or more reference documents in the set. For each particular candidate document, the method computes a second metric value set that quantifies a second knowledge level for the particular candidate document. For each particular candidate document, the method also computes a difference between the first and second metric value sets. This difference represents a knowledge-acquisition level for the several reference documents and the candidate document.

The knowledge-acquisition level quantifies the relevancy and novelty of the particular candidate document, i.e., quantifies how much relevant information would be added to the knowledge base (provided by the reference document set) if the particular candidate document was read or added to the reference document set.

In some embodiments, the method ranks the set of candidate documents based on the difference between the first and second metric value set for each candidate document in the set of candidate documents. The method in some embodiments then provides a presentation of the candidate documents that is sorted based on the rankings.

### BRIEF DESCRIPTION OF THE DRAWINGS

The novel features of the invention are set forth in the appended claims. However, for the purpose of explanation, several embodiments of the invention are set forth in the following figures.

FIG. 1 illustrates a query-less searching and ranking process.

FIG. 2 illustrates a process for computing a metric matrix for a set of documents.

FIG. 3 illustrates a chart that includes a set of attribute values for a passage in a reference documents.

FIG. 4 illustrates a chart after the process has computed sets of attribute values for several passages in several reference documents.

FIG. 5 illustrates the set of attributes values for a set of reference documents in an M×N matrix.

FIG. 6 illustrates how an M×N matrix A can be decomposed.

FIG. 7 illustrates discarding an aligner matrix.

FIG. 8 illustrates a diagonal matrix being reduced.

FIG. 9 illustrates a matrix G that represents a knowledge level for a set of documents.

FIG. 10 illustrates a process that some embodiments use to compute such a learning metric score for a set of candidate documents.

FIG. 11 illustrates a set of attributes values for a candidate document in a M×N matrix.

FIG. 12 illustrates the combined set of attribute values for a set of reference documents and a candidate document in a M×N′ matrix.

FIG. 13 illustrates a computer system in which some embodiments of the invention is implemented.

### DETAILED DESCRIPTION

In the following detailed description of the invention, numerous details, examples and embodiments of the invention are set forth and described. However, it will be clear and apparent to one skilled in the art that the invention is not limited to the embodiments set forth and that the invention may be practiced without some of the specific details and examples discussed.

I. Overview

Some embodiments of the invention provide a method for identifying relevant documents. The method receives a set of reference documents. The method analyzes the received set of reference documents. Based on this analysis, the method then identifies one or more documents that are potentially relevant to the discussion in one or more reference documents.

In some embodiments, the method identifies the relevant documents by examining candidate documents that are on a computer or are accessible by a computer through a computer network (e.g., a local area network, a wide area network, or a network of networks, such as the Internet). In these embodiments, the method uses its analysis of the reference document set to determine whether the discussion (i.e., content) of the candidate document is relevant to the topics discussed in one or more of the reference documents. If so, the method of some embodiments identifies the candidate document as a potentially relevant document (i.e., as a document that is potentially relevant or related to the reference document set).

Other embodiments do not identify a candidate document as a potentially relevant document just because the candidate document's discussion is relevant to the topics discussed in the reference document set. To identify a candidate document as a potentially relevant document, some embodiments require that the candidate document's discussion is sufficiently novel over the discussion in the reference document set. Accordingly, in some embodiments, the method further determines whether each candidate document's discussion is sufficiently novel (e.g., the discussion is new or provides a new context or a new meaning to terms and topics that are discussed in the reference document set) to warrant identifying the candidate document as a potentially relevant document.

In some embodiments, the method prepares a presentation of the potentially relevant documents. A user then reviews the documents identified in this presentation to determine which, if any, are relevant to the discussion in one or more reference documents.

The method of some embodiments analyzes and compares reference and candidate documents as follows. To analyze the reference document set, the method computes a first metric value set for the reference document set. The first metric value set quantifies a first knowledge level provided by one or more reference documents in the set. For each particular candidate document, the method computes a second metric value set that quantifies a second knowledge level for the particular candidate document. For each particular candidate document, the method also computes a difference between the first and second metric value sets. This difference represents a knowledge-acquisition level for the several reference documents and the candidate document.

The knowledge-acquisition level quantifies the relevancy and novelty of the particular candidate document, i.e., quantifies how much relevant information would be added to the knowledge base (provided by the reference document set) if the particular candidate document was read or added to the reference document set.

In some embodiments, the method ranks the set of candidate documents based on the difference between the first and second metric value sets for each candidate document in the set of candidate documents. The method in some embodiments then provides a presentation of the candidate documents that is sorted based on the rankings.

II. Knowledge Acquisition Model

Some embodiments of the invention implement an unsupervised query-less search method that selects new documents based on prior reading. This search method uses latent semantic analysis to map words to vectors in a high-dimensional semantic space. The relative differences in these vectors are used to assess how reading a new document affects the abstract concepts that are associated with each word in the reader's vernacular. The various metrics are applied to measure differences in these associates. The documents are then ranked based on their relative effect on the semantic association of words.

In some embodiments, this search method examines a user's prior reading or writing (e.g., examines documents stored in a folder, such as a MyKnowledge folder, on the user's computer) and then returns a list of new documents (e.g., obtained from online journals) arranged in descending order of maximal learning. The documents that interest the user are then added to the user's collection of prior reading (e.g., the MyKnowledge folder). Whenever adding interesting documents into the prior reading, the search method, in some embodiments, adapts to the user's interests as they evolve. In other words, documents that are added to a user's prior reading are used in a subsequent semantic analysis of the prior reading in these embodiments.

In some embodiments, the search method includes the ability to model knowledge and consequently the change in knowledge. By modeling the user's knowledge before and after reading a document, the method can measure the change in the knowledge of the user. The amount of change in the knowledge of the user is then treated as proxy for learning. The documents that produce the greatest change in the model of knowledge and consequently result in the maximal learning are returned first.

As used herein, the word “document” means any file that stores information. Such a file may comprise text and/or images, such as word processing files, web pages, articles, journals. Before proceeding with a detailed explanation of the some embodiments of the invention, an exemplar of the problem to be resolved by the method is explained.

At the center of the search problem is the need to apply an ordering to the set of D (d₁, . . . , dₙ) of documents. A convenient method to produce an ordering is to construct a map f: D→R and then use the natural ordering of the real number. In this case, a learning metric is used to map each document to the real numbers. As used herein, the word “learning” means a change in knowledge. Thus, the learning metric is defined as L :(k₀, k₁)→R, where k₀ and k₁ are the knowledge models before and after reading the document. A function K: x⊂D→k is defined, which takes a subset of the documents and produces a model of knowledge. Thus, by composition, the method can define the ordering map f[d]=L[K[p]K[p∪{d}]], where p⊂D is the prior reading and the argument d is the candidate document. Having defined the problem and a method for solving the problem, a query less search method is now described.

III. Query-less Searching and Ranking of Documents

A candidate document can fall in one of three classes relative to a set of reference documents. Class I documents are candidate documents that are relevant but not very novel. This means that these candidate documents are very similar to the reference documents, but they don't provide any new or novel information. That is, these candidate documents don't provide information that isn't already found in the reference documents. Since these candidate documents do not add any new information, they do not affect the knowledge model.

Class II documents are candidate documents that are different from the reference documents. In other words, these candidate documents do not contain words that are similar to the reference documents. These candidate documents use different terminology (i.e., different words) than the reference. However, in some embodiments, these candidate documents may be relevant to the reference documents, but because they use different words, they are not classified as relevant.

Class III documents are candidate documents that are both relevant and novel to the reference documents. That is, these candidate documents not only include words that are found in the reference documents, but these words may have slightly different meanings. Therefore, these words are novel in the sense that they provide new information to the user.

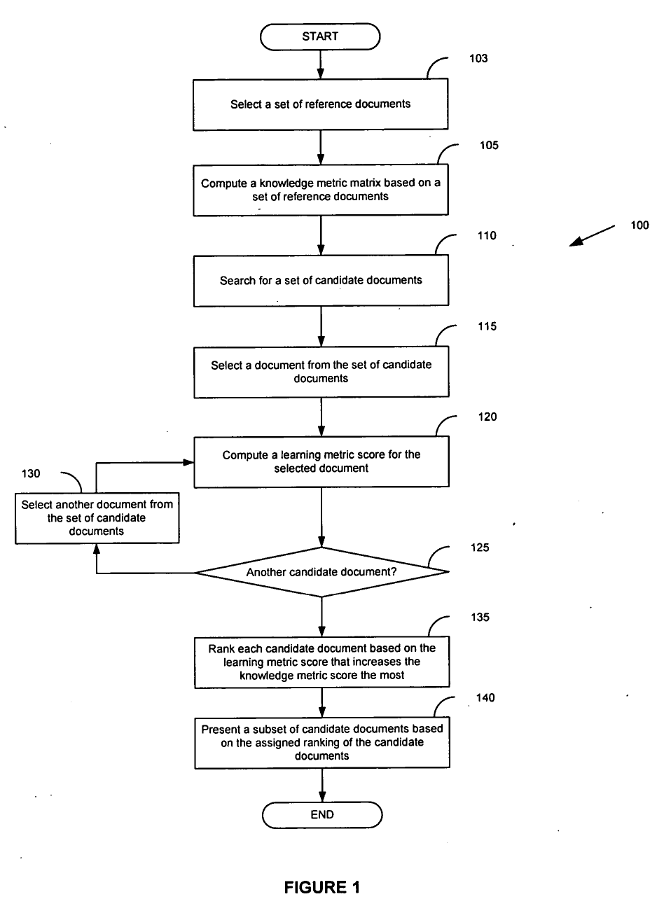

FIG. 1 illustrates a query-less search process 100 that searches for documents and ranks these documents based on their relevancy and novelty. As shown in FIG. 1, the process identifies (at 103) a set of reference documents.

In some embodiments, the set of reference documents is an exemplar group of documents that represents a particular user's knowledge, in general and/or in a specific field. Therefore, in some instances, the set of reference documents may include documents that the particular user has already read. However, in some instances, the set of reference documents may include documents the particular user has never read, but nevertheless may contain information that the user has acquired somewhere else. For example, an encyclopedia may be a document that a user has never read, but probably includes information that the user has acquired in some other document. Additionally, in some embodiments, the set of documents may only include documents that a particular user has stored in a list of documents the user has already read.

Accordingly, different embodiments identify (at 103) the reference document set differently. For instance, in some embodiments, the process autonomously and/or periodically examines documents stored in a folder (such as a MyKnowledge folder) on the user's computer. Alternatively or conjunctively, the process receives in some embodiments a list of or addresses (e.g., URL's) for a set of reference documents from a user.

The process computes (at 105) a knowledge metric value set based on a set of reference documents. In some embodiments, the knowledge metric value set quantifies the level of information a user has achieved by reading the set of reference documents. Different embodiments compute the knowledge metric value set differently. A process for computing a knowledge metric value set for a set of reference documents will be further described in Section IV. The knowledge metric value set is described below in terms of a set of attributes arranged in a matrix. However, one of ordinary skill in the art will realized that the set attribute values can be arranged in other structures.

After computing (at 105) the knowledge metric matrix, the process searches (at 110) for a set of candidate documents. In some embodiments the search includes searching for documents (e.g., files, articles, publications) on local and/or remote computers. Also, in some embodiments, the search (at 110) for a set of candidate documents entails crawling a network of networks (such as the Internet) for webpages. In some embodiments, the search is performed by a web crawler (e.g., web spider) that follows different links on webpages that are initially identified or subsequently encountered through examination of prior webpages. The webcrawler returns the contents of the webpages (or portion thereof) once a set of criteria are met, where they are indexed by a search engine. Different web crawlers use different criteria for determining when to return the contents of the searched webpages.

After searching (at 110), the process selects (at 115) a candidate document from the set of candidate documents. The process then computes (at 120) a learning metric score (also called a knowledge-acquisition score) for the selected candidate document.

Different embodiments compute the learning metric score differently. In some embodiments, the learning metric score quantifies the amount of relevant knowledge a user would gain from reading the candidate document. Some embodiments measure this gain in knowledge relative to the knowledge provided by the set of reference documents. A method for computing the learning metric score is further described below in Section IV.

After computing (at 120) the learning metric score, the process determines (at 125) whether there is another candidate document in the set of candidate documents. If so, the process proceeds to select (at 130) another candidate document from the set of candidate documents. In some embodiments, several iterations of selecting (at 130) a candidate document and computing (at 120) a learning metric score are performed. If the process determines (at 125) there is no additional candidate document, the process proceeds to 135.

The process ranks (at 135) each candidate document from the set of candidate documents based on the learning metric score of each candidate document. Different embodiments may rank the candidate document differently. In some embodiments, the candidate document with the highest learning metric score is ranked the highest, and vice-versa. Thus, during this step, candidate documents are identified based on their respective learning metric scores.

Once the candidate documents have been ranked (at 135), the process presents (at 140) a subset of candidate documents to the user and ends.

In some embodiments, only those candidate documents that are relevant and provide the most novel information (i.e., that increases knowledge the most) are provided to the particular user. In some embodiments, the subset of candidate documents is provided to a user in a folder (e.g., NewDocuments folder). Yet in some embodiments, the subset of candidate documents are provided as search results (such as the way a search engine provides its results), based on the set of reference documents in a folder. In some instances, these candidate documents are sent to the user via a communication medium, such as email or instant messaging. Moreover, these candidate documents may be displayed/posted on a website.

While the above process is described in the context of a query-less search, the process can also be applied to set of candidates that have already been selected by a user. Additionally, the process is not limited to a query-less search. Thus, the process can be used in conjunction with search queries.

Moreover, to improve the subset of candidate documents that are presented to the user, candidate documents that are submitted to the user in some embodiments become part of the user's set of reference documents and subsequent iterations of the process 100 will take into account these candidate documents when computing the metric matrix of the set of reference documents. In some embodiments, only candidate documents that the user has flagged as relevant and/or novel are taken into account in subsequent iterations. In some embodiments, candidate documents that the user has flagged as either not relevant or not novel are used to exclude candidate documents in subsequent iterations. In other words, the process will adjust the type of candidate documents that is provided to a particular user as the particular user's knowledge evolves with the addition of candidate documents.

IV. Computational Knowledge Model

A. Latent Semantic Analysis

Some embodiments analyze a set of documents (e.g., reference, candidate) documents by computing a metric matrix that quantifies the amount of knowledge the set of documents represents. In some instances, this metric matrix is based on a model of knowledge. The model of knowledge is based on the assumption that words are pointers to abstract concepts and knowledge is stored in the concepts to which words point. A word is simply a reference to a piece of information. A document describes a new set of concepts through association of previously known concepts. These new concepts then alter the original concepts by adding new meaning to the original words. For example, the set of words {electronic, machine, processor, brain} evoke the concept of computer. By combining these words, they have now become associated with a new concept.

In some embodiments, the model of knowledge is simply the set of words in the corpus and their corresponding concepts defined by vectors in a high dimensional space. Some function K is then used to take a set of documents and produce the corresponding model of knowledge. In some embodiments, the process implements the function K by applying latent semantic analysis (“LSA”) to the set of documents.

As described earlier, LSA is a powerful text analysis technique that attempts to extract the semantic meaning of words to produce the corresponding high dimensional vector representations. LSA makes the assumption that words in a passage describe the concepts in a passage and the concepts in a passage describe the words. The power of LSA rests in its ability to conjointly solve (using singular value decomposition) this simultaneous relationship. The final normalized vectors produced by the LSA lie on the surface of a high dimensional hyper-sphere and have the property that their spatial distance corresponds to the semantic similarity of the words they represent.

B. Overview of Knowledge Model

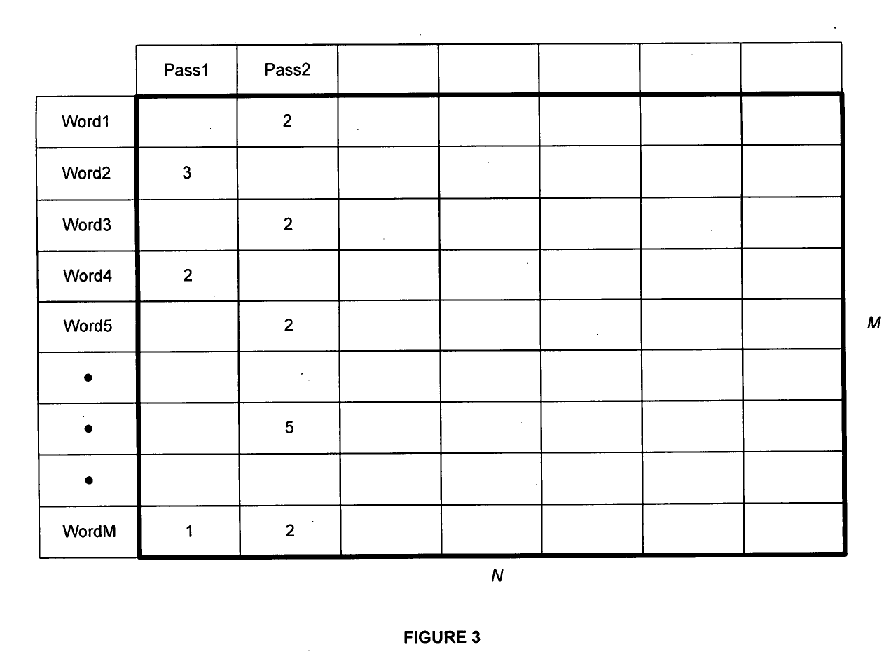

Given a corpus with W words and P passages, the first step in LSA of some embodiments is to produce a W×P word-passage co-occurrence matrix F that represents occurrences of words in each passage of a document. In this matrix F, f_{wp} corresponds to the number of occurrences of the word w in the passage p. Thus, each row corresponds to a unique word and each column corresponds to a unique passage. An example of a matrix F will be further described below by reference to FIGS. 3-5. Commonly this matrix is transformed to a matrix M via some normalization (e.g., Term Frequency-Inverse Document Frequency). This transformation is applied to a frequency matrix constructed over the set of documents, which will be further described below in Section IV.C.

The columns in the augmented frequency matrix M correspond to passages which may contain several different concepts. The next step is to reduce the columns to the principal concepts. This is accomplished by the application of singular value decomposition (“SVD”). Singular value decomposition is a form of factor analysis which decomposes any real m×n matrix A into A=UDV^{T}, where U is an m×n hanger matrix, D is an n×n diagonal stretcher matrix, and V is an n×n aligner matrix. The diagonal matrix D consists of the singular values (the eigenvalues of AA^{T}) in descending order.

Once the augmented frequency matrix has been decomposed, the lowest order singular values in the diagonal matrix are set to zero. Moreover, starting with the lower right of the matrix (e.g., the smallest singular values), the diagonal elements of the matrix D are sequentially set to zero until only j(j=500) elements remain. By matrix multiplication, the method computes the final w×j matrix G, where the matrix G represents a hanger matrix U multiplied by the reduced version of the matrix D (G=UD_{reduced}). The row vector G_{w} corresponds to the semantic vector for word w. For simplicity, the row vectors are then normalized onto the unit hypersphere (∥v∥=1). In the method, the matrix G, which defines concept point for each word, is the model of knowledge k and the knowledge construction function K is defined by LSA.

C. Method for Computing a Metric Matrix

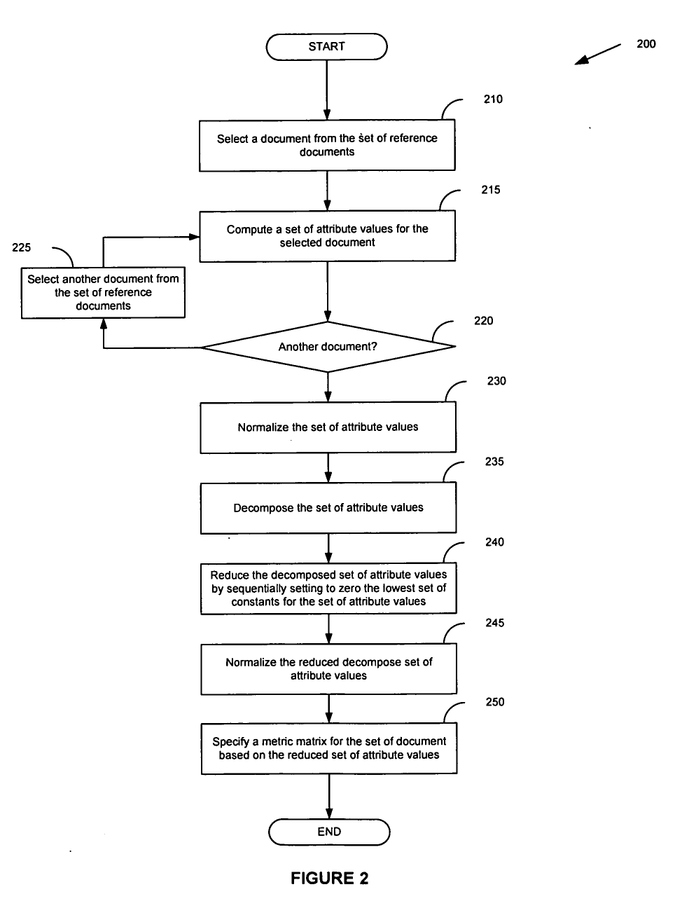

As mentioned above, some embodiments of the invention compute a knowledge metric matrix for a set of reference documents to quantify the knowledge that a particular user has. FIG. 2 illustrates a process 200 that some embodiments use to compute such a knowledge metric matrix. This process 200 is implemented in step 105 of the process 100 described above in some embodiments.

The process selects (at 110) a document from a set of reference documents. The process computes (at 115) a set of attribute values for the selected reference documents. In some embodiments, the set of attribute values are the number of times particular words appear in the selected reference documents. Thus, for each distinct word, the process computes how many times that particular word appears in the reference documents. In some embodiments, these word occurrences are further categorized by how many times they appear in a particular passage of the reference document. A “passage” as used herein, means a portion, segment, section, paragraph, and/or page of a document. In some embodiments, the passage can mean the entire document.

FIG. 3 illustrates how a process might compute a set of attribute values for a reference document. As shown in this figure, the words “Word2”, “Word4” and “WordM” respectively appear 3, 2 and 1 times in the passage “Pass 1”.

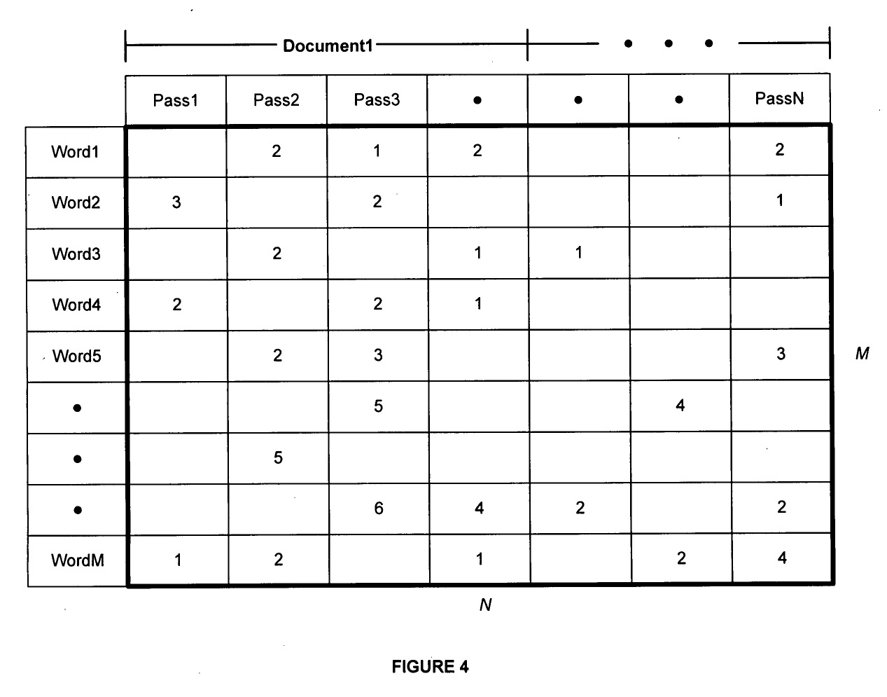

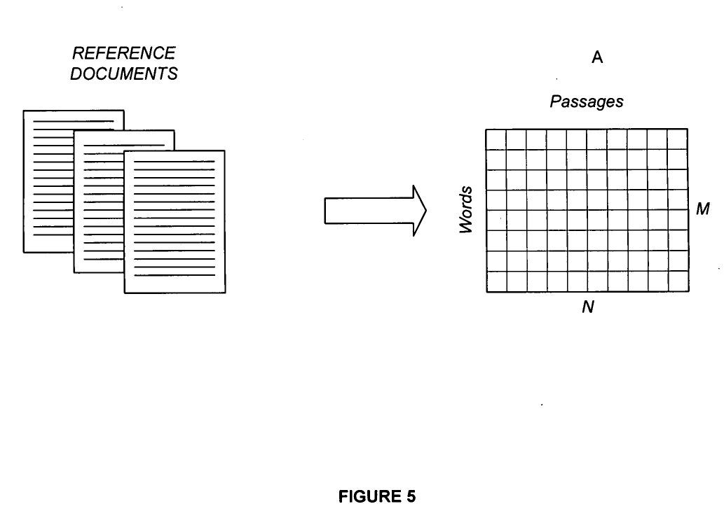

The process determines (at 220) whether there is another document in the set of reference documents. If so, the process selects (at 225) another reference document and proceeds back to 215 to compute a set of attribute values for the newly selected reference document. In some embodiments, several iterations of selecting (at 225) and computing (at 215) a set of attribute values are performed. FIG. 4 illustrates a chart after the process has computed sets of attribute values for several reference documents. The chart of FIG. 4 can be represented as an M×N matrix, as illustrated in FIG. 5. This matrix 500 represents the set of attribute values for the set of reference documents. As shown in this matrix 500, each row in the matrix 500 corresponds to a unique word, and each column in the matrix 500 corresponds to a unique passage.

The process (at 230) normalizes the set of attribute values. In some embodiments, normalizing entails transforming a matrix using term frequency-inverse document frequency (“TF-IDF”) transformation. Some embodiments use the following equation to transform a matrix into a W×P normalized matrix M, such that m_{wp} corresponds to the number of occurrences of the word w in the passage p.

$$\begin{matrix}{H}_{w} = \frac{{\sum }_{p = 1}^{P} \frac{{f}_{wp}}{{f}_{w}} log [ \frac{{f}_{wp}}{{f}_{w}} ]}{log [ P ]} & ( 1 ) \\ {m}_{wp} = log [ {f}_{wp} + 1 ] ( 1 - {H}_{w} ) & ( 2 )\end{matrix}$$

where w corresponds to a particular word, p corresponds to a particular passage (i.e., document), H_{w} corresponds to the normalized entropy of the distribution, f_{wp} corresponds to the number of occurrences of the word w in the passage p, and P corresponds to the total number of passages.

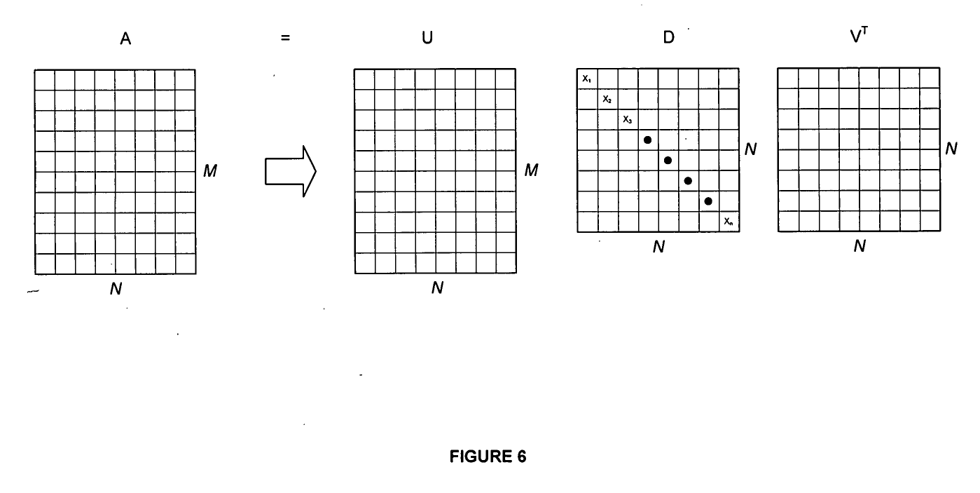

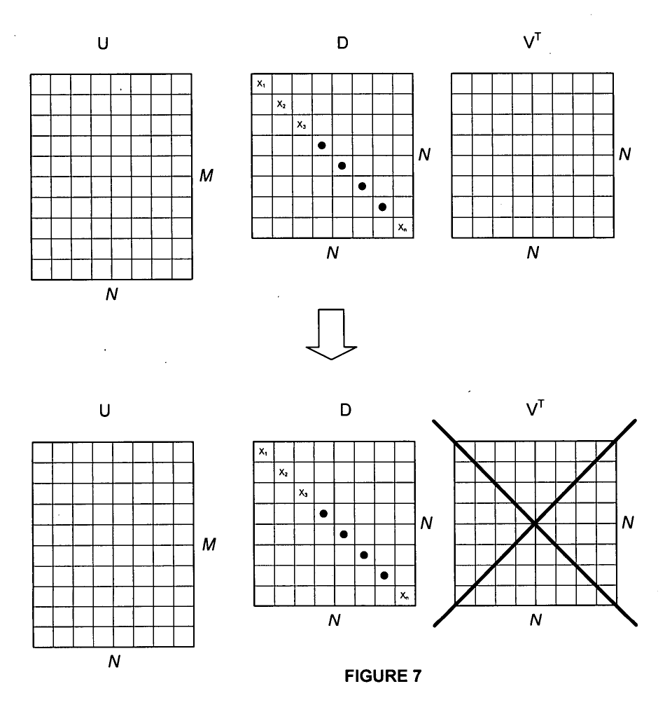

After normalizing (at 230) the set of attribute values, the process decomposes (at 235) the set of attribute values. Different embodiments decompose the set of attribute values differently. As mentioned above, some embodiments use singular value decomposition (“SVD”) to decompose the set of attribute values. FIG. 6 illustrates how an m×n matrix A can be decomposed. As shown in this figure, the matrix A can be decomposed into three separate matrices, U, D, and V^{T}, respectively. Thus, matrix A can be decomposed using the following equation:
A=UDV^{T} (3)

where U is a m×n hanger matrix, D is a n×n diagonal stretcher matrix, and V is an n×n aligner matrix. The D matrix includes singular values (i.e., eigenvalues of AA^{T}) in descending order. As shown in FIG. 7, the aligner matrix V^{T} is disregarded from further processing during process 200. In some embodiments, the D matrix includes constants for the decomposed set of attribute values.

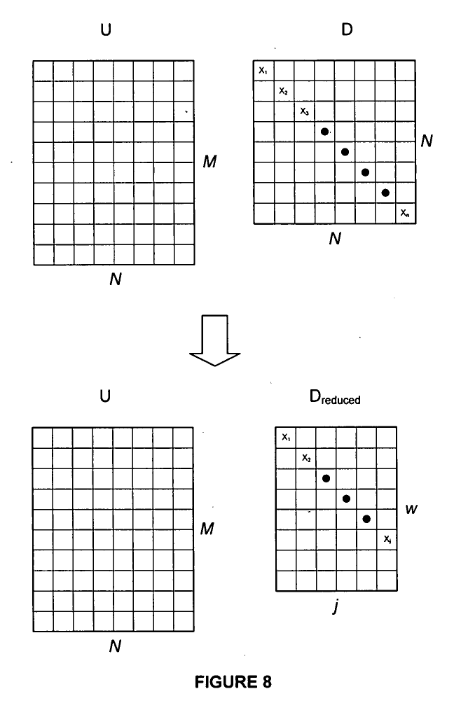

Once the set of attribute values has been decomposed (at 235), the process reduces (at 240) the decomposed set of attribute values. In some embodiments, this includes assigning a zero value for low order singular values in the diagonal stretcher matrix D. In some embodiments, assigning zero values entails sequentially setting to zero the smallest singular elements of the matrix D until a particular threshold value is reached. This particular threshold is reached when the number of elements is approximately equal to 500 in some embodiments. However, different embodiments may use different threshold values. Moreover, some embodiments sequentially set the remaining singular elements to zero by starting from the lower right of the matrix D. FIG. 8 illustrates the matrix D after is has been reduced (shown as matrix D_{reduced}).

After 240, the process normalizes (at 245) the reduced decomposed set of attributes. In some embodiments, this normalization ensures that each vector in the reduced set of attributes has length of 1.

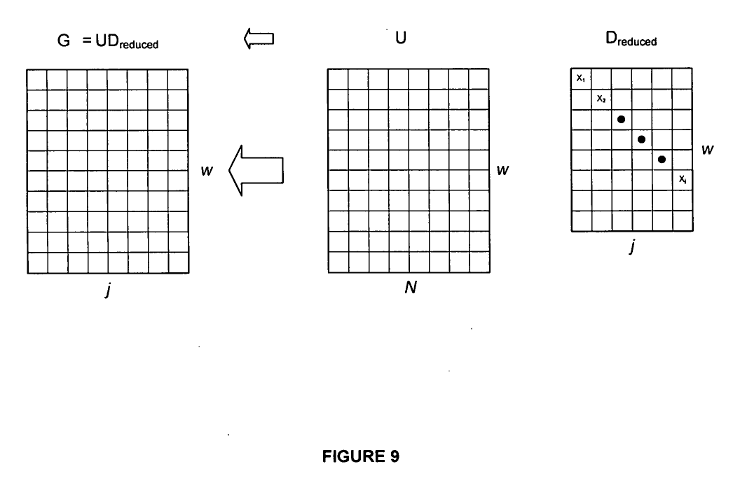

After normalizing (at 245), the process specifies (at 250) a metric matrix for the document (e.g., reference, candidate) based on the reduced set of attribute values and ends. In some embodiments, the knowledge metric matrix for a set of reference documents can be expressed as the matrix U multiplied by the matrix D_{reduced} (U D_{reduced}), as shown in FIG. 9.

V. Learning Model

A. Overview of Learning Model

As previously mentioned, the learning function may be used to measure the change in the meaning of a word. In this learning model, new words introduced by the candidate document are not considered because they affect K₁ indirectly through changes in the meaning of the words in K₂. This learning function L measures the difference between two levels of knowledge k₀=K[p]εR^{wxj} and k₁=K[p+{d}]εR^{wxj}, where p is the prior reading set and d is the candidate document. Thus, the function L is defined as:

$$L = Δ {\sum }_{∀ w} {( {k}_{0} )}_{w} \cdot {( {k}_{1} )}_{w} \qquad ( 4 )$$

where Δ: R^{k}xR^{k}→R computes the difference between two word vectors. A typical measure of semantic difference between two words is the cosine of the angle between the two vectors. This can be computed efficiently by taking the inner product of the corresponding normalized word vectors. If the cosine of the angle is close to 1 then the words are very similar and if it is close to −1 then the words are very dissimilar. Several studies have shown the cosine measure of semantic similarity agrees with psychological data. Finally we obtain the complete definition of the learning function and the ordering map by using the following equation:

$$\begin{matrix}L = {\sum }_{∀ w} {( {k}_{0} )}_{w} \cdot {( {k}_{1} )}_{w} & ( 5 ) \\ f [ d ] = {\sum }_{∀ w} {( K [ p ] )}_{w} \cdot {( K [ p ⋃ \{ d \} ] )}_{w} & ( 6 )\end{matrix}$$

where p is again the prior reading. The f function is applied to each candidate document and the documents with the highest value for f are returned first.

B. Process for Computing Learning

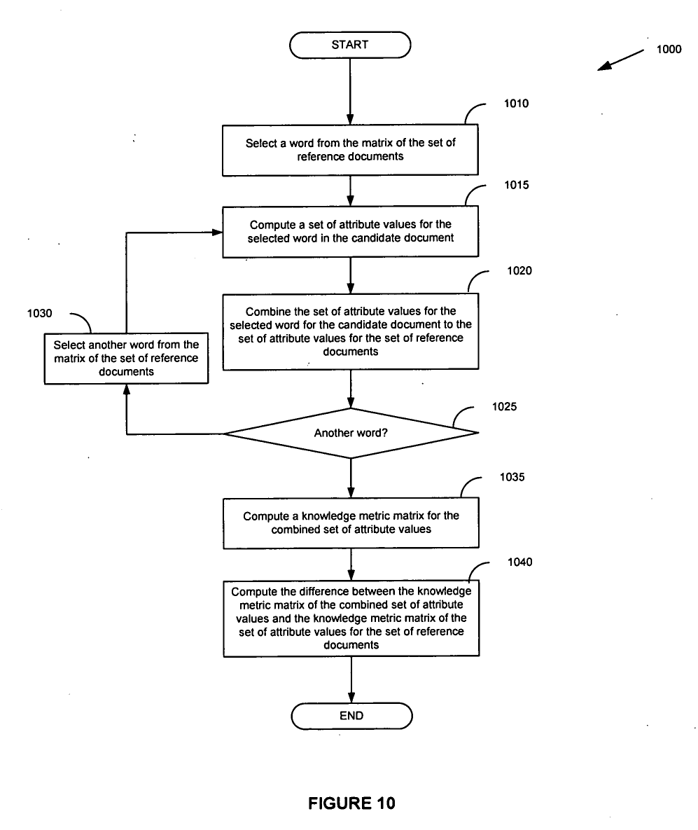

As mentioned above, some embodiments of the invention compute (at 120) a learning metric score for a candidate document to quantify the amount of knowledge a user would gain by reading the candidate document. FIG. 10 illustrates a process 1000 that some embodiments use to compute such a learning metric score for a candidate document.

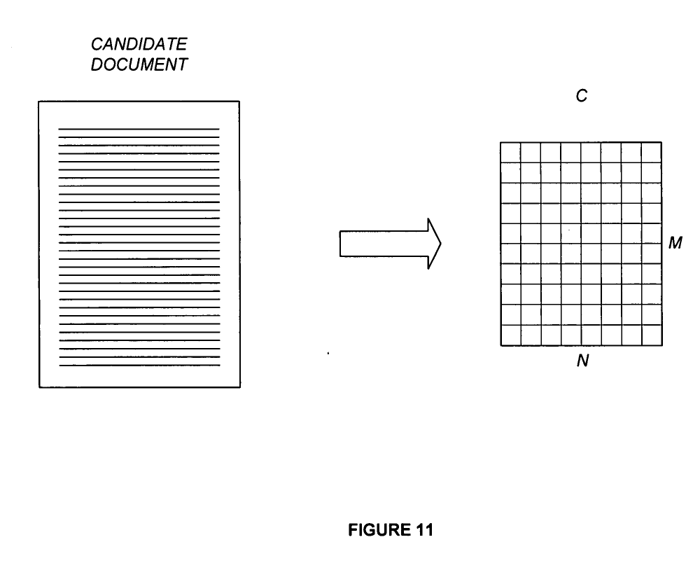

The process selects (at 1010) a word from the metric matrix of the set of reference documents. The process computes (at 1015) a set of attribute values for the selected word in the candidate document. In some embodiments, the set of attributes include the number of times the selected word appears in each passage of the candidate document. Thus, computing the set of attributes entails computing for each passage in the candidate document, the number of times the selected word appears. The computed set of attribute values for this candidate document can be represented as a matrix, as shown in FIG. 11. In some embodiments, this matrix is computed using the process 300 described above for computing the matrix for the set of reference documents.

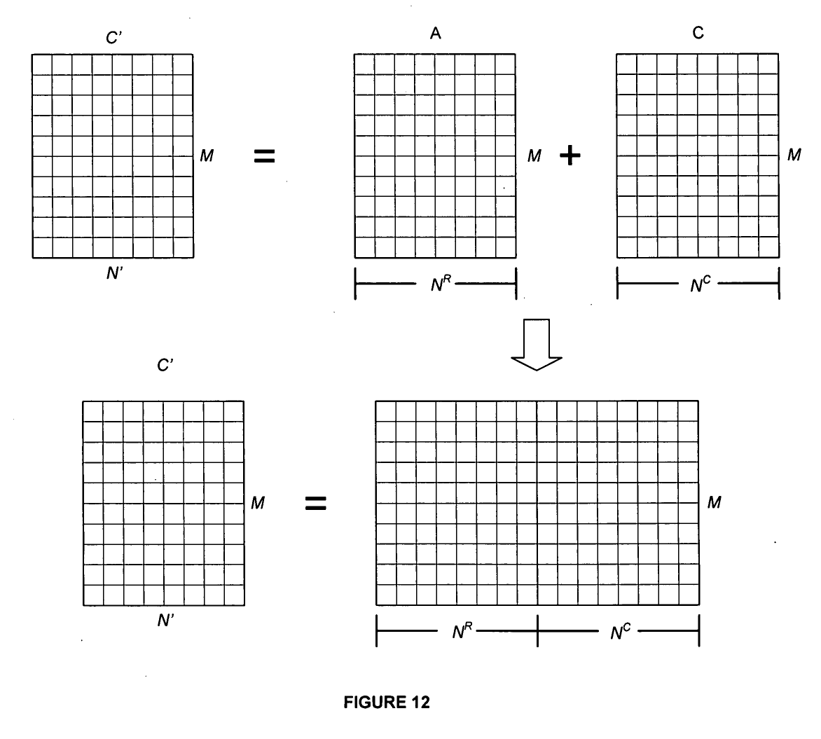

After computing (at 1015) the set of attribute values for the selected word, the process combines (at 1020) the set of attribute values of the selected word for the candidate document to the set of attribute values for the set of reference documents. Once the set of attribute values has been combined (at 1020), the process determines (at 1025) whether there is another word. If so, the process selects (at 1030) another word from the set of reference documents and proceeds to 1015 to compute a set of attribute values. In some embodiments, several iterations of computing (at 1015), combining (at 1020) and selecting (at 1030) are performed until there are no more words to select. FIG. 12 illustrates a matrix after the set of attribute values for the set of reference documents and the candidate document are combined.

After determining (at 1025) there are no additional words, the process computes (at 1035) a knowledge metric matrix for the combined set of attribute values for the set of reference documents and the candidate document (e.g., Matrix C′ shown in FIG. 12). Some embodiments use the process 200, described above, for computing such a knowledge metric matrix.

Once the metric matrix is computed (at 1035), the process computes (at 1040) the difference between the metric matrices of the set of reference documents and the candidate document and ends. This difference is the learning metric score. In some embodiments, this difference is a semantic difference, which specifies how a word in one context affects the same word in another context. In other words, this semantic difference quantifies how the meaning of the word in the candidate document affects the meaning of the same word in the set of reference documents.

Different embodiments may use different processes for quantifying the semantic difference. Some embodiments measure the semantic difference between two words as the cosine of the angle between the vectors of the two words. In such instances, this value can be expressed as the inner product of the corresponding normalized word vectors. When the value is close to 1, then the words are very similar. When the value is close to −1, then the words are very dissimilar. As such, the semantic difference between a set of attributes values for a set of reference documents and a candidate document can be expressed as the inner product between the set of attribute values for a set of reference documents and the set of attribute values for a combination of the set of reference documents and the candidate document.

VI. Computer System

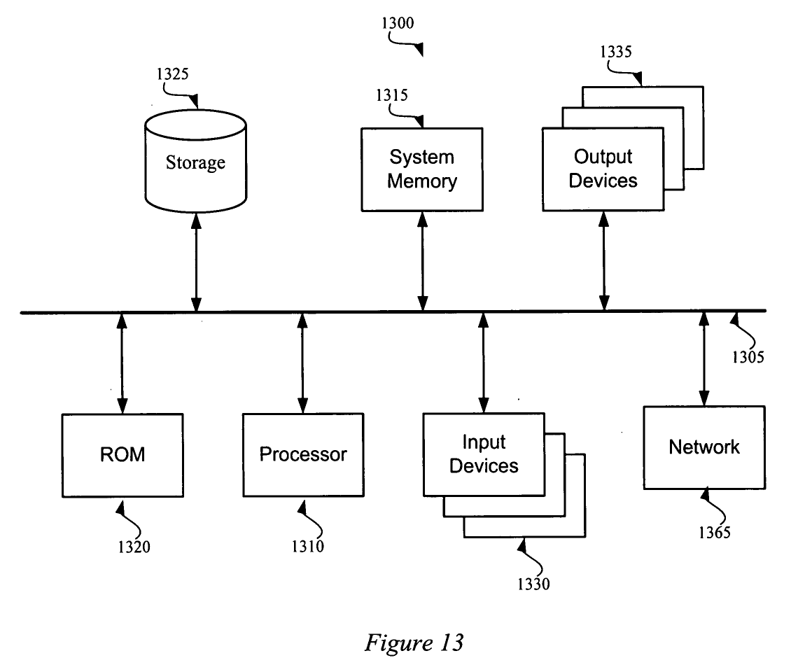

FIG. 13 conceptually illustrates a computer system with which some embodiments of the invention is implemented. Computer system 1300 includes a bus 1305, a processor 1310, a system memory 1315, a read-only memory 1320, a permanent storage device 1325, input devices 1330, and output devices 1335.

The bus 1305 collectively represents all system, peripheral, and chipset buses that support communication among internal devices of the computer system 1300. For instance, the bus 1305 communicatively connects the processor 1310 with the read-only memory 1320, the system memory 1315, and the permanent storage device 1325.

From these various memory units, the processor 1310 retrieves instructions to execute and data to process in order to execute the processes of the invention. The read-only-memory (ROM) 1320 stores static data and instructions that are needed by the processor 1310 and other modules of the computer system. The permanent storage device 1325, on the other hand, is a read-and-write memory device. This device is a non-volatile memory unit that stores instruction and data even when the computer system 1300 is off. Some embodiments of the invention use a mass-storage device (such as a magnetic or optical disk and its corresponding disk drive) as the permanent storage device 1325. Other embodiments use a removable storage device (such as a floppy disk or zip® disk, and its corresponding disk drive) as the permanent storage device.

Like the permanent storage device 1325, the system memory 1315 is a read-and-write memory device. However, unlike storage device 1325, the system memory is a volatile read-and-write memory, such as a random access memory. The system memory stores some of the instructions and data that the processor needs at runtime. In some embodiments, the invention's processes are stored in the system memory 1315, the permanent storage device 1325, and/or the read-only memory 1320.

The bus 1305 also connects to the input and output devices 1330 and 1335. The input devices enable the user to communicate information and select commands to the computer system. The input devices 1330 include alphanumeric keyboards and cursor-controllers. The output devices 1335 display images generated by the computer system. The output devices include printers and display devices, such as cathode ray tubes (CRT) or liquid crystal displays (LCD).

Finally, as shown in FIG. 13, bus 1305 also couples computer 1300 to a network 1365 through a network adapter (not shown). In this manner, the computer can be a part of a network of computers (such as a local section network (“LAN”), a wide section network (“WAN”), or an Intranet) or a network of networks (such as the Internet). Any or all of the components of computer system 1300 may be used in conjunction with the invention. However, one of ordinary skill in the art will appreciate that any other system configuration may also be used in conjunction with the invention.

While the invention has been described with reference to numerous specific details, one of ordinary skill in the art will recognize that the invention can be embodied in other specific forms without departing from the spirit of the invention. For example, the above process can also be implemented in a field programmable gate array (“FPGA”) or on silicon directly. Moreover, the above mentioned process can be implemented with other types of semantic analysis, such as probabilistic LSA (pLSA) and latent dirlechet allocation (“LDA”). Furthermore, some of the above mentioned processes are described by reference to users who provide documents in real time (i.e., analysis is performed in response to user providing the documents). In other instances, these processes are implemented based on reference documents that are provided as query-based search results to the user (i.e., analysis is performed off-line). Additionally, instead of receiving a set of reference documents by a particular user, the method can be implemented by receiving from the particular user, the location of the set of reference documents (i.e., the location of where the reference documents are stored). In some embodiments, the method can be implemented in a distributed fashion. For instance, the set of documents (e.g., reference, candidate) is divided into a subset of documents. Alternatively or conjunctively, some embodiments use multiple computers to perform various different operations of the processes described above. Thus, one of ordinary skill in the art would understand that the invention is not to be limited by the foregoing illustrative details, but rather is to be defined by the appended claims.

What is claimed is:

1. A method for identifying a set of relevant documents, the method comprising:
a. receiving a plurality of reference documents;
b. analyzing the plurality of reference documents; and
c. identifying a set of potentially relevant documents based on the analyzed plurality of reference documents

2. The method of claim 1, wherein analyzing the plurality of reference documents comprises computing a first metric value set, wherein the first metric value set quantifies a knowledge level for the plurality of reference documents.

3. The method of claim 2, wherein computing the first metric value set comprises:
a. computing a set of attribute values for a plurality of reference documents;
b. decomposing the set of attribute values; and
c. reducing the set of attribute values.

4. The method of claim 1, wherein identifying the set of potentially relevant documents comprises iteratively:
a. analyzing during each iteration, each potentially relevant document in the set of potentially relevant documents;
b. comparing during each iteration, each potentially relevant document in the set of potentially relevant documents to the plurality of reference documents.

5. The method of claim 4, wherein analyzing the set of potentially relevant documents comprises computing a second metric value set for each potentially relevant document in the set of potentially relevant documents.

6. The method of claim 4, wherein a difference between the first and second metric value set quantifies the knowledge acquisition level from the plurality of reference documents to the potentially relevant documents.

7. The method of claim 4, wherein comparing comprises computing an inner product between the first and second metric value sets.

8. The method of claim 7, wherein the second metric value set is based on a combination of the plurality of reference documents and the potentially relevant documents.

9. The method of claim 7, wherein the difference between the first and second metric value sets is expressed as a metric score.

10. The method of claim 1 further comprising of presenting a subset of the identified set of potentially relevant documents, wherein the subset of the identified set of candidate documents are potentially relevant documents that are the most relevant to the plurality of reference documents.

11. The method of claim 1, wherein receiving a plurality of reference documents comprises receiving the reference documents from a particular user.

12. The method of claim 1, wherein receiving a plurality of reference documents comprises receiving the location of the reference documents from a particular user.

13. A method for determining the relevance of a set of candidate documents relative to a plurality of reference documents, wherein the method comprises:
a. computing a first metric value set for the plurality of reference documents, wherein the first metric value set quantifies a first knowledge level provided by the plurality of reference documents;
b. computing a second metric value set for a candidate document from the set of candidate documents, wherein the second metric value set quantifies a second knowledge level for the candidate document; and
c. computing a difference between the first and second metric value sets, wherein the difference quantifies a knowledge acquisition level between the plurality of reference documents and the candidate document.

14. The method of claim 13 further comprising of iteratively:
a. computing a second metric value set for each candidate document from the set of candidate documents; and
b. computing a difference between the first and second metric value sets, for each candidate document from the set of candidate documents.

15. The method of claim 14 further comprising of ranking each candidate documents from the set of candidate documents based on the difference between the first and second metric value sets of each candidate document from the set of candidate documents.

16. The method of claim 13, wherein computing the metric value set comprises determining the number of occurrence of a particular word in the document.

17. The method of claim 16, wherein the computing the metric value set further comprises determining the number of occurrence of a particular word in a particular potion of the document.

18. The method of claim 13, wherein computing a first metric value set comprises:
a. computing a set of attribute values for the plurality of reference documents;
b. decomposing the set of attribute values; and
c. reducing the set of attribute values.

19. The method of claim 18, wherein decomposing comprises using singular value decomposition.

20. The method of claim 19, wherein reducing the set to attribute values comprises setting the lowest set of singular value elements to zero.

21. The method of claim 13, wherein computing a second metric value set comprises:
a. computing a set of attribute values for a set of candidate document;
b. combining the set of attribute values for the set of candidate document to a set of attribute values for the plurality of documents;
c. decomposing the combined set of attribute values; and
d. reducing the combined set of attribute values.

22. The method of claim 13, wherein computing the difference comprises computing an inner product of the first and second metric value sets.
